(19) United States
(12) Patent Application Publication
(10) Pub. No.: US 2026/0322695 A1
(43) Pub. Date: Oct. 15, 2026

(54) SYSTEM AND METHOD FOR CREATING A PRIVATE SERVICE ACCESS NETWORK

(71) Applicants: Som SIKDAR, San Jose, CA (US); Jeffrey Michael COLLINS, Brighton, CO (US)

(72) Inventors: Som SIKDAR, San Jose, CA (US); Jeffrey Michael COLLINS, Brighton, CO (US)

(21) Appl. No.: 19/116,527

(22) PCT Filed: Sep. 29, 2023
(86) PCT No.: PCT/US2023/034230

§ 371 Date: Mar. 28, 2025

Related U.S. Application Data
(60) Provisional application No. 63/377,863, filed on Sep. 30, 2022.

(51) Int. Cl. H04L 41/0895; H04L 41/12; H04L 41/40; H04L 41/5054; H04L 49/354

(52) U.S. Cl. CPC H04L 41/0895; H04L 41/12; H04L 41/40; H04L 41/5054; H04L 49/354

(57) ABSTRACT

A method of creating a private service access network is provided. The method includes receiving information corresponding to network parameters for accessing one or more network services by one or more clients and creating a plurality of code and configuration packages that, when executed, each implement a respective software node of a plurality of software nodes. The plurality of software nodes implements the network parameters for accessing the one or more network services by the one or more clients. Each of the plurality of code and configuration packages is deployed to the execution environment corresponding to the execution environment information in that code and configuration package. The one or more execution environments execute the respective code and configuration package deployed thereto such that the plurality of software nodes are implemented providing selective access to the one or more network services.

### BACKGROUND

Security for networks connecting devices and users across distributed locations is typically implemented by a plurality of network nodes including routers and firewalls that manage access to resources within the network. Large networks have a vast number of such devices to be managed in order to implement the desired security and access.

FIG. 1 is a flow diagram of an existing method 100 for building a private network. First, a system administrator (or administration team) procures a plurality of networking devices (e.g., routers, firewalls) to use as the components for the private network (block 102). Typical networking devices are highly configurable, including a large number of settings so that the device can be tailored to the specific needs of the network and support a large number of features. Depending on the size of the private network, it may be necessary to individually identify and purchase more than one hundred networking devices. After procuring the devices, the system administrator manually configures each of the networking devices so that each networking device performs its intended function (block 104). Each networking device may require a significant number of parameters that need to be set. The system administrator must also physically place each of the networking devices at the desired location (block 106). Networking devices may be required at many different places throughout a building, campus, and/or across multiple geographic locations requiring the administrator to physically travel to each of the locations. The administrator must then physically connect any cabling to each of the networking devices (block 106). Each cable must be carefully connected to the correct physical interface of the network device to ensure proper operation. Once all of the network devices are positioned, connected, and activated, the system administrator tests the network to ensure it works as intended (block 108). If any feature does not work as intended the system administrator will need to manually examine the networking device(s) to identify and correct the error (block 110). This can include physically traveling to, examining, and adjusting the settings of one or more networking devices. If the error is due to a hardware failure, new hardware may need to be procured and set-up or otherwise worked around.

Unfortunately, with the large number of devices to be procured, cables to the connect, and parameters to be set, errors in the network set-up are common and can be difficult to diagnose. Moreover, each adjustment to the network (e.g., move, add, or change), whether to replace an existing networking device or add one or more new networking devices, requires a similar process and has the same potential for errors as during the initial set-up.

One development that can reduce the work required in building and maintaining a private network is software-defined networking. Software-defined networking uses devices that are implemented in software to perform networking functions. The software-defined devices can run on generic hardware such as a server. Such software-defined devices have the same large number of features and parameters as traditional physical devices. The software-defined devices can be easier to configure and update because their parameters can often be set and adjusted via a network API. Thus, a system administrator can simply log-in to the networking device and manually set, check, or update the settings of the software-defined device. This reduces the need to physically travel to each networking device to inspect and update.

### SUMMARY OF THE INVENTION

Embodiments described herein provide for a method of creating a private service access network. The method includes receiving information corresponding to network parameters for accessing one or more network services by one or more clients and creating a plurality of code and configuration packages that, when executed, each implement a respective software node of a plurality of software nodes. The plurality of software nodes implements the network parameters for accessing the one or more network services by the one or more clients. Each of the plurality of code and configuration packages includes execution environment information corresponding to an execution environment in which the respective code and configuration package is to be executed. The network parameters include a plurality of virtual private network (VPN) tunnels between the plurality of software nodes, user-based access restrictions for the network services, and one or more routing tables for routing packets through the plurality of software nodes. Each of the plurality of code and configuration packages is deployed to the execution environment corresponding to the execution environment information in that code and configuration package. The one or more execution environments execute the respective code and configuration package deployed thereto such that the plurality of software nodes are implemented providing selective access to the one or more network services.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a flow diagram of an existing method for building a private network;

FIG. 2 is a block diagram of an example system including a private service access network (PSAN) that can be built and maintained in accordance with the embodiments described herein;

FIG. 3 is a block diagram of an example software system for building and maintaining the PSAN of FIG. 1;

FIG. 4 is a block diagram of an example embodiment of the system of FIG. 3;

FIG. 5 is a flow diagram of an example method for building and/or maintaining a PSAN using the system of FIG. 3;

FIG. 6 is a block diagram of an example PSAN built by the system of FIG. 3 and the method of FIG. 5.

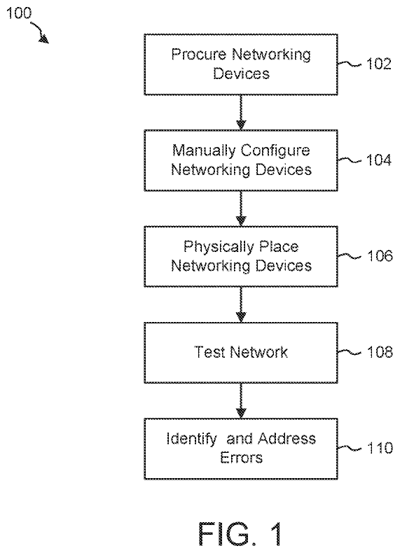

### DETAILED DESCRIPTION

Embodiments described herein provide systems and methods for building and maintaining a private service access network. Although existing software-defined networking solutions can provide some improvement to the task of building a multi-site private network, software-defined networking solutions that span across multiple locations and/or use equipment from multiple vendors are still prone to difficult configuration errors and security vulnerabilities. This is further complicated when the sites are different types, for example a mix of physical data centers and clouds. Differing speeds and feeds of each location (e.g., 1 Gbs vs. 10 Gbs or one vs. multiple network interfaces) can also cause complications. The embodiments described herein provide a means of building and maintaining a network that increases the ease with which the network can be created and updated. The embodiments described herein address these shortcomings by generating an end-to-end network including complex topologies that can also address some of the security vulnerabilities of existing networks. The systems and methods accomplish this by providing a programmatic way to create and deploy a plurality of network nodes, their interconnects, user requirements and site requirements all contemporaneously and in one process.

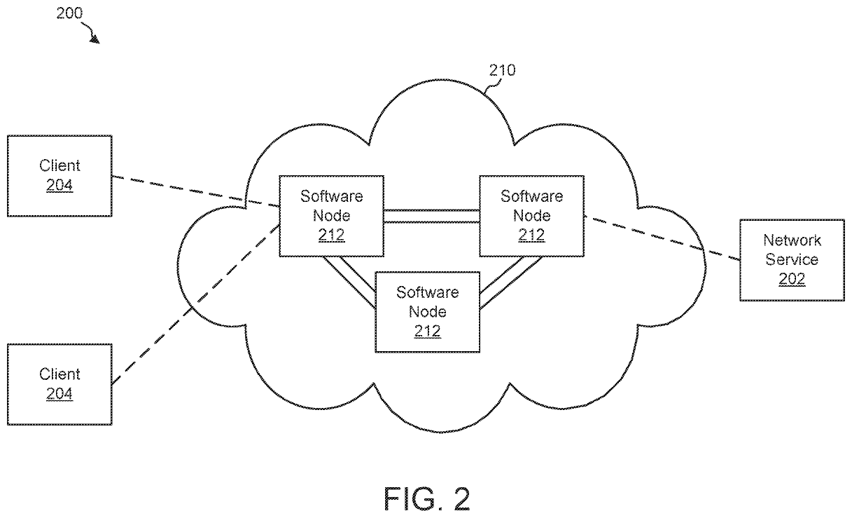

FIG. 2 is a block diagram of an example system 200 including a private service access network (PSAN) 210 that can be built and maintained in accordance with the embodiments described herein. The PSAN 210 provides selective access to one or more network services 202 for a plurality of clients 204. Each network service 202 is software executing in an execution environment 206, such as a virtual machine, virtual operating system (OS), bare metal server, or other infrastructure. Example network services 202 include Microsoft Exchange, file servers, sharepoint, billing services, printers, and others. Each client 204 is software executing in an execution environment 208, such as a personal computing device (PC) (e.g., desktop, laptop, tablet, mobile phone), virtual machine, virtual OS, or other infrastructure. Example clients 204 include user applications such as Microsoft Outlook and Microsoft Word, and embedded software, such as firmware executing on a component of a process control system. Execution environment(s) 208 for the client(s) 204 can be the same or different from execution environment(s) 206 of the service(s) 204.

The PSAN 210 includes a plurality of software nodes 212 that cooperate to provide selective access to the network service(s) 204 for the clients 204. Each software node 212 is software executing in an execution environment, such as a virtual machine, virtual OS, bare metal server, or other infrastructure. The software nodes 212 provide networking services (e.g., OSI layer 3 and OSI layer 4 services) to enable selective communication between the clients 204 and the network service(s) 202. The layer 3 and layer 4 services can include network address translation (NAT), routing of packets, IP discovery, and tunneling of packets among other things. At least a subset of the software nodes 212 are configured to implement one or more IP networks, wherein each software node 202 of the subset operates as an IP networking device. Example networking devices implemented by a software node 212 include a router/gateway that performs protocol translation, a switch that does not perform protocol translation, and an encryption/decryption device.

FIG. 2 illustrates the logical (e.g., overlay) network connections implemented by the system 200. That is, the network services, clients, and software nodes are configured to send packets between one another over the logical network connections. Each logical network connection can include zero, one, or multiple physical network links (e.g., an Ethernet or Wi-Fi link). For example, if a software node 212 is executing on the same physical device as a client 204, the client 204 and the software node 212 can exchange packets by sending the packets over a logical network connection between itself and the software implementing the client 204 without traversing any physical network links. In contrast, if a software node 212 is executing on an Internet connected server and the client 204 is connecting to the Internet from a remote location, there may be numerous physical network links and likely multiple distinct autonomous systems between the client 204 and the software node 212. Packets sent between such a software node 212 and client 204 can be routed through the Internet in the normal manner based on the IP addresses of the client 204 and the software node 212. The network connection between the network service(s) 202 and the software nodes 212 as well as between respective software nodes 212 are also logical (e.g., overlay) network connections.

The PSAN 210 provides selective network connections between the clients 204 and the network service(s) 202. The PSAN 210 limits access to the network service(s) 202 based on access permissions for the PSAN 210. Software nodes 212 implement the access permissions such that access to the network service(s) 202 is restricted, except as allowed by the configuration rules. In this way, access to the network service(s) 202 is controlled by the software nodes 212 of the PSAN 210.

The access permissions indicate which clients 204 are allowed access to which network resources 202 and the conditions under which that access is allowed. Any suitable conditions can be placed on a client's access including user-based restrictions, device-based restrictions, location-based restrictions, time-based restrictions, and others. User-based restrictions can include which users operating a client (e.g., user accounts logged into on the client) are allowed access to which network services 202. Device-based restrictions can refer to a particular client 204 or physical device (e.g., a MAC address). Location-based restrictions can include the network location of the client 204 (e.g., the LAN or sub-net that the client 204 is a part of) or a physical location of a device on which the client 204 executes (e.g., GPS coordinates). Time-base restrictions can include a time of day, a day of week, or length of time from grant of access (e.g., 1 week), A combination of multiple conditions can also be required such as a device-based restriction and a time-based restriction. In any case, the access permissions indicate the conditions under which a client 204 is to be granted access to a particular network service 202. In an example, the software nodes 212 implement the access permissions by only providing network connections between a client 204 and network service 202 if the access permissions indicate that the client 204 is allowed to access the network service 202. If a network access request from a client 204 meets the conditions defined in the access permissions, a path is provided between the client 204 and the network service 202. If the network access request does not meet the conditions defined in the access permissions, no path is provided by the software nodes 212 and, therefore, access to the network service 202 is denied.

The PSAN 210 can be implemented across a public network, such as the Internet, providing private network access between the clients 204 and the network service(s) 202 over the public network. To implement the network connections of the PSAN 210 in a private manner, the software nodes 212 can be configured to implement tunnels (e.g., IPSEC, WebSocket) between themselves and the clients 204 and the network service(s) 202 as well as between one another.

In an example, the software nodes 212 can implement a virtual private network that is invisible to the clients 204. To do so, a first software node 212 can be deployed within a private network in which the clients 204 are also within. The first software node 212 can be configured with a network connection to the network service(s) 202. The network connection to the network service(s) 202 can occur over a public network and can be a direct connection with the network service(s) 202 or can hop through one or more intermediate software nodes 212. The first software node 212 can also act as a gateway for the clients 204 by providing IP discovery for the network service(s) 202 within the private network of the clients 204 such that the clients 204 can discover the network service(s) 202 using known discovery protocols, such as DNS. The first software node 212 can also provide network address translation to translate between network addresses in the private network and network address in the public network. Each of these configurations (the network connection, NAT, and IP discovery) is a network parameter of the PSAN 210 that is implemented by the first software node 212. The system 200 can similarly implement a virtual private network that is invisible to the network service(s) 202 by deploying a second software node 202 within a private network in which the network service(s) 202 is located.

In another example, the client 204 can be configured to connect with a software node 212 that is deployed in the public network. In such an example, the client 204 can be manually configured with the parameters for the network connection to the software node 212 in the public network. These parameters can include, for example, the public network address of the software node 212 and tunnel parameters for setting up a tunnel with the software node 212. The software node 212 can be configured with a network connection to the network service(s) 202. The network connection to the network service(s) 202 can occur over a public network and can be a direct connection with the network service(s) 202 or can hop through one or more intermediate software nodes 212.

One or more software nodes 212 can be configured as intermediate software node 212 that route packets between respective network connections. Such intermediate software nodes 212 can be disposed at locations that provide for efficient routing of packets across the PSAN 210. For example, a first intermediate software node 212 can be disposed in a first location that has efficient access to a first and a second set of clients 204 (e.g., a first and second private network of which the clients 204 are a part). A second intermediate software node 212 can be disposed in a second location that has efficient access to a third and fourth sets of clients 204. The first intermediate software node 212 can have a network connection to the first private network and a network connection to the second private network. In this way, the first intermediate software node 212 can provide efficient access linking the clients 204 of the first private network to services 202 in the second private network and vice versa. Similarly, the second intermediate software node 212 can provide efficient access linking the clients 204 of a third private network to services 202 in a fourth private network and vice versa. A network connection between the first software node 212 and the second software node 212 can provide network connections between the first and second private networks and the third and fourth private networks. This is merely a simple example but illustrates how intermediate software nodes 212 can be deployed at desired locations to provide efficient network communications.

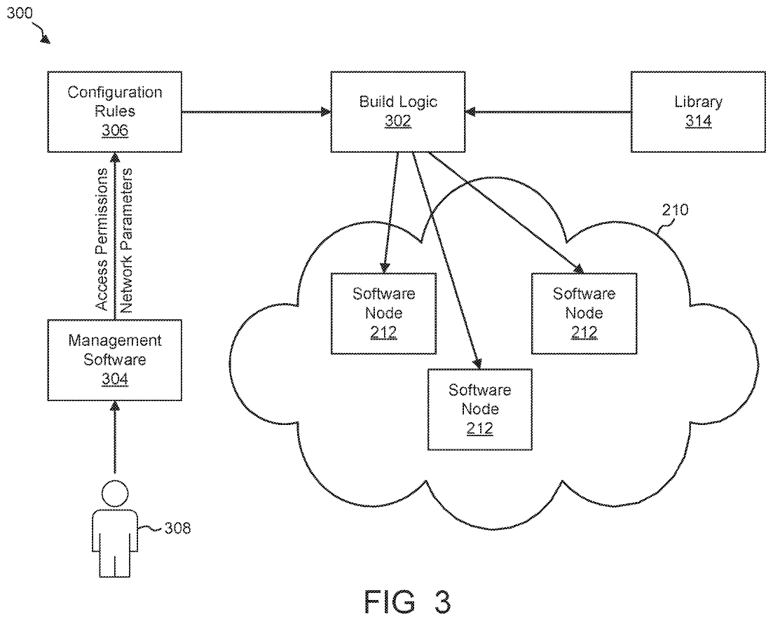

FIG. 3 is a block diagram of an example software system 300 for building and maintaining the PSAN 210. System 300 includes build logic 302 that creates the software nodes 212. The build logic 302 creates the software nodes 212 based on configuration rules 306. The configuration rules 306 are a collection of information that includes the network parameters for the PSAN 210. The configuration rules 306 are accessible to the build logic 302, and the build logic 302 creates the software nodes in accordance with the configuration rules 306. The network parameters in the configuration rules 306 incorporate the access permissions for the PSAN 210, such that the creation of the software nodes 212 in accordance with the configuration rules 306 implements the access permissions in the PSAN 210.

The system 300 includes management software 304 which is configured to receive information from an administrator 308 for the system 300 and maintain the configuration rules 306 based thereon. The management software 304 can provide a management portal that receives the information from the administrator 308 and displays information regarding the system 300 to the administrator 308. The management software 304 maintains the configuration rules 306 by updating the rules 306 such that they reflect information received from an administrator 308. The management software 304 can include any suitable mechanism for authenticating the administrator 308 and maintaining the configuration rules 306.

The configuration rules 306 can be stored in any suitable format and in any suitable location. For example, the configuration rules 306 can be stored in a database or immutable ledger. To maintain the configuration rules 306, the management software 304 updates the database or adds to the immutable ledger such that the current configuration rules in the database or immutable ledger reflects any updated information received from the administrator 308.

To build the PSAN 210, the build logic 302 creates and activates the plurality of software nodes 212. Software nodes 212 include a software data plane having a plurality of ports for sending and receiving packets. The software data plane of a software node receives, processes, and forwards packets between the plurality of ports in order to implement the desired function for the software node 212. For software nodes 212 that implement layer 3 and/or layer 4 networking functions, processing the packets includes determining which port to forward the packets too. The software nodes 212 can implement part or all of the access restrictions by only forwarding packets that are allowed by the access permissions. That is, if there is no allowance for a packet that is defined in the configuration rules and built into a software node 212, the packet will not be forwarded by that software node 212 and access to network service(s) for that packet will be denied. By referencing the configuration rules 306, the build logic 302 creates each software node 212 as a unique entity that implements the functions defined for it in the configuration rules 306.

Each software node 212 is a package of code and configuration that is designed to execute within an execution environment and perform certain functions. The code and configuration package and the execution environment for that package can have any suitable form. In an example, the code and configuration packages are respective Docker containers and the execution environments are respective Docker Engines. In other examples, however, the code and configuration packages and the execution environments can have different forms such as a virtual machine and a hypervisor. In yet other examples, the code and configuration packages are applications and the execution environments are an operating system. In still other examples, the code and configuration package is a pre-configured secure vendor appliance that can act as an aggregator or gateway to a secure group of devices such as IoT sensors. The package of code and configuration can consist of multiple submodules of code and several types of configuration information. An example is a Docker compose file or a Kubernetes Helm chart that builds up the code functionality using multiple smaller service containers. In still other examples, a mix of different types of code and configuration packages and execution environments can exist in a single PSAN 210, with every code and configuration package matched in type to its execution environment.

The PSAN 210 can utilize multiple execution environments to execute the plurality of software nodes 210. The execution environments can be established at one or more physical locations as needed to implement the functions of the PSAN 210. For example, the execution environments can be established on one or more private servers (e.g., within a private network), one or more public servers (e.g., AWS or Google servers), and/or one or more lambda functions. In any case, information pertaining to each execution environment available for the PSAN 210 is included in the configuration rules 306. Execution environment information can include information used to communicate with the execution environment. This execution environment information can include, for each execution environment, a unique ID, a network address for the environment, credentials for the environment, network port(s) for the environment, and a type of environment. The unique ID can be any suitable uniquely identifiable code, such as an alpha-numeric code or name. The network address and port(s) are the network locations with which the build logic 302 can communicate with the execution environment. In an example, the network address is an IP address and the network port(s) are TCPIP ports or SSH ports. The credentials can include the encryption protocol and/or key used for communication between the build logic 302 and the execution environment. In an example, the type of execution environment can include one of an operating system on a device, a virtual machine, a virtual OS, or a bare metal server. Each execution environment can have access parameters associated therewith that enable the build logic 302 to access the execution environment, such as an SSH Key, firewall rules, software submodule versions, and lists of network ports and protocols for use with automation software such as Terraform from software companies like HashiCorp. Via these access parameters, the build logic 302 can send code packages to each execution environment and instruct the execution environments regarding activation of each code package (e.g., instructions to activate or disable a particular code package).

To create a software node 212, the build logic 302 accesses the configuration rules 306 to identify one or more functions to be implemented by a software node 212. The build logic 302 pulls from a library 308 one or more code functions corresponding to the one or more functions to be implemented by a software node 212. The build logic 302 creates a code package that includes and links the one or more code functions and configures each of the one or more code functions such that the combination of one or more code functions work together to implement the specific functions defined for the software node 212 in the configuration rules 306. For example, if a first software node 212 is to implement an IPSEC tunnel path to a second software node 212, the build logic 302 pulls the code function for an IPSEC tunnel, configures the code function to implement the specific IPSEC tunnel, and includes the code function in the code package for the first software node 212. This can be used to create, for example, a software node 212 that terminates IPSEC or Wireguard VPN links, decrypts the payload, performs appropriate network routing or Network Address Translation (NAT) functions, and/or provides GRE/MPLS encapsulation/de-capsulation/switching. When the code package is executed, that code function creates an IPsec tunnel with the IP address of the second software node 212. The build logic 302 similarly creates the second software node 212 by again pulling a copy of the code function for an IPsec tunnel and including configuration parameters to create an Ipsec tunnel with the first software node 212. In this way, the build logic 302 creates first and second software nodes 212 that implement an IPsec tunnel therebetween. The build logic 302 can also assign private IP addresses to the software nodes 212 for use as endpoints for network connections. In an example, a function can include encapsulating and decapsulating packets to and from public IP address to provide a public IP backhaul. Once all the desired code functions are included in a code package, the code package can be compiled for execution within a specific execution environment.

As mentioned above, the build logic 302 creates a plurality of software nodes 212 in accordance with the network parameters defined in the configuration rules 306. The network parameters can include, for each software node 212, a unique identifier (e.g., a unique name and/or alpha-numeric code), and a type of node (e.g., router, encryption node, etc.). An encryption/decryption node, for example, encrypts and/or decrypts packets and forwards the packets.

The network parameters in the configuration rules 306 can also include parameters for the (logical) network connections implemented by the system 200. The network connection parameters can include routing information such as public or private IP addresses for the network connection, where a software node 212 sends a particular packet, when to establish a path to another software node, one or more routing tables for sending packets across the network connections, and what protocol to use for packets sent over that path. Example protocols that can be used include tunneling protocols such as IPsec and SSL.

The network parameters in the configuration rules 306 can also include client information. Client information can include a unique identifier (e.g., a unique name and/or alpha-numeric code) for each client 204 of the PSAN 210, a network address (e.g., IP address) for the client 204, one or more ports for the client 204, and one or more network services 202 or network paths that the client is allowed to access.

The combination of network path parameters and client parameters can be part of implementing the access permissions as discussed above. For example, if the client parameters indicate that User 1's account is allowed access to Service 1, and the path parameters indicate that an IPsec tunnel is to be created between Client 1 and Service 1, then the software nodes 212 will provide access for User 1 to Service 1 when User 1 is logged onto Client 1. If, however, there is no parameter allowing User 1 to access Service 1 or nor parameter providing a network connection between Client 1 and Service 1, the software nodes 212 will not forward packets from Client 1 to Service 1 and User 1 will not be allowed access to Service 1 from Client 1.

The build logic 302 also creates a configuration package for the code package. The configuration package includes parameters for the code package that are specific to the execution environment it will be sent to, such as geographic location, CPU resources, and access keys.

After assembling the code and configuration package that will perform the functions of a software node 212 as defined in the configuration rules 306, the build logic 302 deploys and activates the software node 212. Deploying the software node 212 includes sending the code and configuration package for the software node 212 to its execution environment. In an example, the code and configuration package for each software node 212 can be sent to the address (e.g., IP address) of the execution environment (e.g., Docker Engine) assigned in the configuration rules 306 to execute that node 212. The build logic 302 can then activate each code package to execute in the assigned execution environment. Upon execution by the execution environment, a software node 212 implements that path and/or other function(s) that the build logic 302 included in its code package. In this way, the system 300 can create and implement the private service network 210.

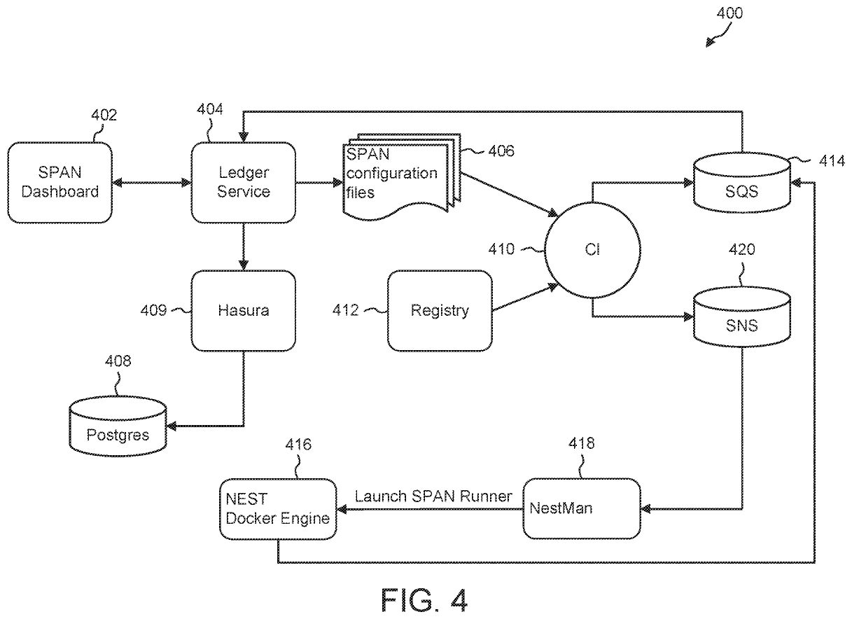

FIG. 4 is a block diagram of an example embodiment 400 of system 300. Embodiment 400 includes a dashboard 402 which implements the interface between the administrator 308 (not shown in FIG. 4) and the system 300 described in the management software above. The dashboard 402 can communicate with a configuration rule service 404. The configuration rule service 404 can be part of the management software 304 described with respect to FIG. 3 and can maintain a set of configuration rules 406 based on information received from the dashboard 402. The configuration rules 406 can include the network parameters for the PSAN 210 as described above. The configuration rule service 404 also maintains a persistent database 408 with information corresponding to the configuration rules 406. The database 408 can be implemented with appropriate interface software 409 such as Hasura. In this example, the configuration rules 406 are not implemented in persistent storage so that the rules 406 can be read more quickly by the build logic 410. The build logic 410 can access the configuration rules 406 to create the software nodes 212 for the PSAN 210 as described with respect to FIG. 3. The build logic 410 stores information corresponding to each software node 212 in a registry 412. The build logic 410 uses a queue service 414 (e.g., simple queue service (SQS) from Amazon) to send a code and configuration package to an execution environment 416 and to communicate with the execution environment(s) 416 to activate and deactivate code packages. In an example, the execution environments 416 are Docker Engines. The queue service 414 communicates with an execution manager 418 which manages an execution environment 416. The build logic 410 can also use a global messaging service 420 to send and receive messages. The dashboard 402 can also receive information from the configuration rule service 404 to display information, such as a network configuration and/or metric, of the embodiment 400 and/or PSAN 210. The dashboard 402 can display the information for consumption by the administrator 308.

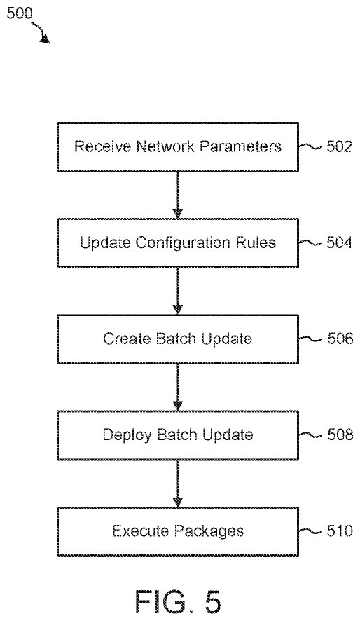

FIG. 5 is a flow diagram of an example method 500 for building and/or maintaining a PSAN 210 using the system 300. To create and update the configuration rules 306, the management software 304 receives one or more network parameters from an administrator 308 (block 502). The management software 304 can execute within an execution environment that has access to a human machine interface (HMI). The HMI can receive inputs corresponding to network parameters from the administrator 308 and send an indication of the inputs to the management software 304. The management software 304 can interpret the inputs from the HMI to obtain information corresponding to network parameters for the PSAN 210. In an example, a portion of the management software 304 can reside on a device that is communicatively coupled over a network to the device with the HMI. Thus, information indicative of the inputs received from the HMI can be sent over a network (e.g., the Internet) to the other portion of the management software for further processing.

In response to receive information corresponding to an update to the PSAN 210 from the administrator 308, the management software 304 updates the configuration rules 306 to incorporate the network parameters received from the administrator (block 504). In examples where the configuration rules 306 are maintained in an immutable ledger, updating the configuration rules 306 can include adding one or more entries (e.g., blocks) to the immutable ledger.

The build logic can create a batch update to the PSAN 210 in accordance with updates to the configuration rules 306 (block 506). The batch update can be initiated at any appropriate time including in response to receiving information corresponding to an update to the PSAN 210 or at periodic intervals. In an example, the management software 304 can send a message to the build logic 302 indicating that an update to the configuration rules 306 has been made. The build logic 302 can analyze the update to determine what actions are needed to implement the update in the PSAN 210. In some situations, the update will include creating one or more new software nodes 212. To create a new software node 212, the build logic 302 creates a code and configuration package that includes the parameters defined in the configuration rules 306 for that software node 212 as discussed above. This includes creating and compiling the code package for execution within a specific execution environment. In some situations, an update to the configuration of an existing software node 212 may be sufficient to update the PSAN 210. In such a situation, the build logic 302 can create a new configuration file for a software node 212 and/or a message to update an existing configuration file for a software node 212. In any case, the build logic 302 can include the code and configuration packages, configuration files, and/or messages in a batch update for the PSAN 210. The build logic 210 can use any appropriate continuous integration and/or continuous development (CI/CD) pipeline to create the batch update.

The build logic 302 can deploy the batch update to implement the changes in the PSAN 210 (block 508). Deploying the batch update includes sending the code and configuration packages, configuration files, and/or messages to the appropriate execution environments. In an example, the code and configuration packages, configuration files, and/or messages can be sent over a network (e.g., the Internet) to the IP address for the respective execution environment. For example, to implement a new software node 212 within a first execution environment, the code and configuration package for the new software node 212 can be sent to the IP address for the first execution environment. The new software node 212 can replace an existing software node 212 executing within the first execution environment and/or can supplement any code currently executing in the first execution environment. Configuration files and/or messages can similarly be sent to the appropriate execution environments to update and/or supplement the code and/or configuration files within those execution environments.

The execution environments can execute respective code packages that incorporate the batch updates sent from the build logic 302 (block 510). Upon execution, the code packages implement the software nodes 212 defined in the configuration rules. In this way, the PSAN 210 can be implemented in accordance with the information provided by the administrator 308.

System 300 and method 500 have several advantages over existing network schemes. Firstly, the process of building out the access network is greatly simplified. In existing systems, each firewall must be individually and manually configured to implement the desired access rules. For large access networks this can be a time consuming process. Secondly, the access control system is much easier to update. If a new access permission is to be granted or an existing access permission removed or changed, the administrator 308 need not figure out which firewalls are to the updated and how. Instead, the administrator 308 can simply input the new/changed/removed access control permission into the management software 304 and the system will take care of the rest. The management software 304 will add the new/changed/removed access control permission to the configuration rules 306 and the build logic 302 will create new software node(s) 212 to implement the access control permission. If necessary, the build logic 302 will disable existing software node(s) 212 and replace them with new software node(s) 212 that implement the new access control permissions.

Third, there is less chance of inadvertent misconfiguration of the PSAN 210. Changes to the configuration rules 306 are automatically implemented by the build logic 302, which includes removal of prior granted permissions that have since been revoked. Thus, the PSAN 210 always provides up-to-date access control. Existing systems that rely on manual updating of firewalls are prone both to IT personnel not following through on removing all previous granted access and to IT personnel unintentionally setting a firewall to allow access that should not be allowed. Because such unintentional access is granted at an individual firewall it may not be very visible to an administrator. The present system, in contrast, all settings changeable by an administrator 308 are global setting visible in the management software 304. Thus, an inadvertent change is more visible to the administrator 308.

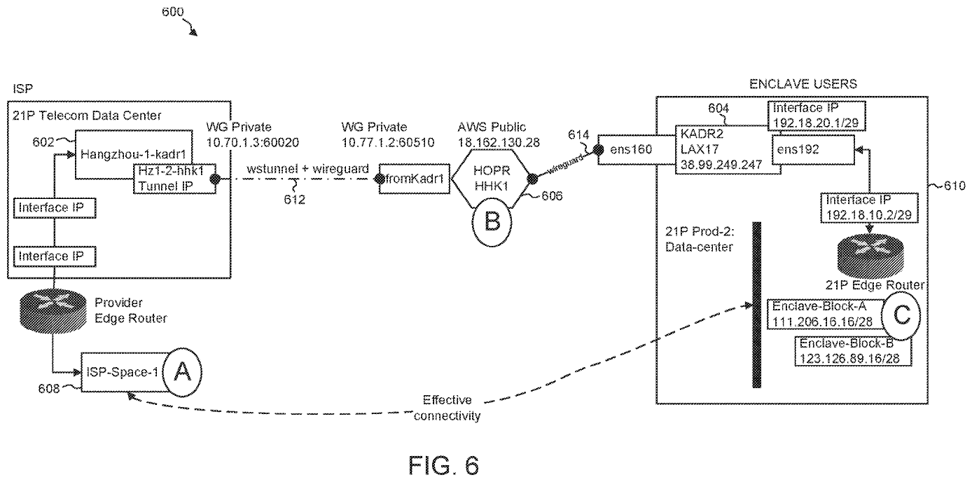

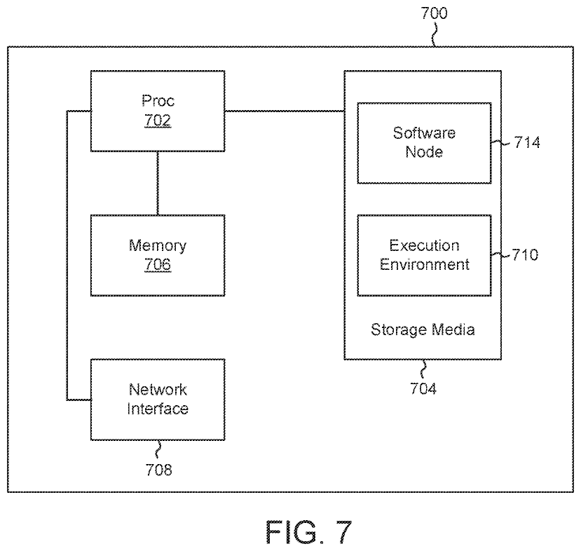

FIG. 6 is a block diagram of an example PSAN 600 built by system 300 and with the method 500. PSAN 600 includes three software nodes 602, 604, 606. PSAN 600 operates to provide a network connection between a first enclave 608 (e.g., located in China) and a second enclave 610 (e.g., located in the United States). Each enclave 608, 610 includes a defined set of IP addresses (e.g., a block of IP addresses from an ISP) and can correspondingly include a plurality of clients communicating over IP networks. In an example, each enclave 608, 610 includes one or more local area networks (LANs). The PSAN 600 operates to provide network connectivity to network services in the first enclave 608 for clients within the second enclave 610. A first software node 602 operates as an endpoint for a logical network connection between the first software node 602 and the second software node 604. In accordance with the corresponding configuration rules, the build logic creates the first software node 602 such that it performs the functions of a gateway for the first enclave 608. In an example, the first software node 602 can advertise reachability of the network service(s) in the first enclave 608 to the clients in the second enclave 610 via the network connection formed therebetween. In an example, the second software node 604 can perform the functions of a gateway for the second enclave 610. Thus, the second software node 604 can forward the reachability advertisements from the first software node 602 to the clients of the second enclave 610. The third software node 606 operates as an intermediate node, wherein logical network connection between the first software node 602 and the second software node 604 includes a first logical network link 612 between the first software node 602 and the third software node 606 and a second logical network link 614 between the third software node 606 and the second software node 604. In an example, each logical network link 612, 614 is a tunnel (e.g., IPsec, SSL) between the respective software nodes 602, 604, 606. In this example, the third software node 606 operates to forward and translate packets between the first logical network link 612 implementing a first tunneling protocol (e.g., IPsec) and the second logical network link 614 implementing a second tunneling protocol (e.g., SSL).

As discussed above, the parameters of each software node 602, 604, 606, including the particular execution environment that they execute within, the other software nodes 602, 604, 606 that they form tunnels with, the tunneling protocols used for those tunnels, and the IP networks (e.g., LANs) of the enclaves that they communicate with are defined in the configuration rules for the PSAN. The build logic creates and deploys each of the software nodes 602, 604, 606 in accordance with the configuration rules to implement the PSAN 600. An example code and configuration package for the first software node 602 includes a Docker compose file and a Docker config file. An example of the Docker compose file is below:

# KADR1 in ISP Headend
# EC2 instance
#
# Aggregates link tunnels from smaller subnets/branches/
nodes and provides subnet level IP forwarding
#
#
#
version: “3”
services:
wireguard:
# image: cmulk/wireguard-docker:alpine
# image: registry.gitlab.com/karousels.dev/karousels.span/
sourcegroup/wireguard-docker:alpine
image: registry.gitlab.com/karousels.dev/karousels.span/
sourcegroup/wireguard-docker:alpine-debug
container_name: kadr1_wg
privileged: true
cap_add:
NET_ADMIN
SYS_MODULE
volumes:
./config:/etc/wireguard/
/lib/modules:/lib/modules
/sys:/sys:rw
restart: unless-stopped
network_mode: host
wstunnel:
image:
registry.gitlab.com/karousels.dev/karousels.span/
sourcegroup/wstunnel
container_name: kadr1-wstun
restart:
unless-stopped
tty: true
environment:
WS_TUN_CLIENT = 1
UDP_TIMEOUT = 9000
LOCAL_TO_REMOTE = 10.70.1.3:60020:10.77.1.2:60510
SERVER_ADDRESS = MyServer1.somedomain.com:443
# - RESTRICT_TO_ADDRESS = 10.77.1.2:60510
depends_on:
wireguard
networks:
kadr1_local_net:
ipv4_address: 10.70.1.3
networks:
kadr1_local_net:
driver: bridge
ipam:
driver: default
config:
subnet:
10.70.1.0/29
## EOF - LL

The build logic includes, in the Docker compose file, code to run one or more container images. Each container image performs a function defined in the configuration rules for the first software node 602. In this example, the first software node 602 is to implement a wstunnel on top of a wireguard tunnel between itself and the third software node 606. Thus, the build logic includes an image for wireguard container (image: registry.gitlab.com/karousels.dev/karousels.span/sourcegroup/wireguard-docker:alpine-debug) as well as an image for the wstunnel container (image: registry.gitlab.com/karousels.dev/karousels.span/sourcegroup/wstunnel) in the Docker compose file. The images can be stored in a private repository such as GitLab. In an example, one or both of the container images can be built by the built logic contemporaneously with the Docker compose file and customized specifically for the first software node 602 in order to implement specific aspects of the desired functions. In an example, one or both of the container images can be multi-node applicable (e.g., pre-existing) that can be run for the first software node 602 as well as other software nodes.

In this example, the container images are multi-node applicable and customized aspects are included in a separate Docker config file. An example Docker config file for the first software node 602 is below:

# CustomerOne-Production
# ISP-Site-1-1 transit SPAN
# Tunnel to HHZ-1
#
#
# Private Key:
oPYbLTv3wolNXh2ZkVTSR1zmUGA2C2hCmKCucQaICEE=
# Public Key:
JKY7kL/aZhzAGaDopt7JfF4sH3LTjiMCZq2Eh0holmc=
#
#
[Interface]
#
Address =
fdac:134e:70f8:cf04:0000:0002:0000:0101/64
MTU =
1420
PrivateKey =
oPYbLTv3wolNXh2ZkVTSR1zmUGA2C2hCmKCucQaICEE=
PostUp =
sysctl net.ipv4.conf.all.src_valid_mark = 1
PostUp = sysctl net.ipv4.ip_forward = 1
PostUp = sysctl net.ipv6.conf.all.disable_ipv6 = 0
PostUp =
iptables -A FORWARD -i %i -j ACCEPT;
iptables -A FORWARD -o %i -j ACCEPT
PostDown =
iptables -D FORWARD -i %i -j ACCEPT;
iptables -D FORWARD -o %i -j ACCEPT
[Peer]
#
# Peer #1
# Defines the trunk to HOPR in Hong-kong
Publickey =
oh/YHc + fSjqYPRXKPiZNJHGOBMGbQPetgQr5mhZFaAs=
# Endpoint =
127.0.0.1:60020 # Hit the local wstun service to Hongkong
AWS HOPR -- LL 5.13.2022
Endpoint =
10.70.1.3:60020 # Hit the local wstun service to Hongkong
AWS HOPR -- LL 5.13.2022
AllowedIPs =
10.10.1.0/28, 198.18.20.1/32
AllowedlPs =
10.10.10.48/28
AllowedIPs =
10.10.20.96/28
AllowedIPs =
10.77.1.0/29 # HHK1 hopr local bridge subnet
PersistentKeepalive = 20
# EOF - LL

This config file defines the allowed IP addresses to and from which packets will be forwarded to/from the tunnel implemented between the first software node 602 and the third software node 606. The config file also indicates the first software node's private key for decrypting packets received over the tunnel from the third software node 606 and indicates the third software node's public key for encrypting packets sent over the tunnel to the third software node 606. The config file also defines the IP address (“Endpoint”) at which the first software node 602 sends and receives packets via the tunnel.

An example code and configuration package for the second software node 604 includes a Docker compose file and a Docker config file. An example Docker compose file is below:

# KADR2 at dataCenter04
#
#
version: “3”
services:
KADR:
# image: registry.gitlab.com/karousels.dev/karousels.span/
sourcegroup/wireguard-docker:alpine
image: registry.gitlab.com/karousels.dev/karousels.span/
sourcegroup/wireguard-docker:alpine-debug
container_name: CustomerOne_kadr2_dataCenter11
privileged: true
cap_add:
NET_ADMIN
SYS_MODULE
volumes:
. /config:/etc/wireguard/
/lib/modules:/lib/modules
/sys:/sys:rw
network_mode: host
restart: unless-stopped

The above code and configuration package is a Docker compose file for the second software node 604. In this example, the second software node 604 is to implement a wireguard tunnel between itself and the third software node 606. Thus, the build logic includes an image for wireguard container (image: registry.gitlab.com/karousels.dev/karousels.span/sourcegroup/wireguard-docker:alpine-debug) in the Docker compose file.

An example Wireguard config file for the second software node 604 is below:

#
#
#Private Key:
8HkZRtr + Tv8qxWYCZPHyBIVQP2Nvs39X/cD9jNYWVXs=
#Public Key:
L2dqLB04TbyMcEdlAs9HK36IMTqZl1lqvcxbZW6ts38=
#
# KADR2 - K9dataCenter11
34.x.y.244 (public), 198.18.20.1 (enclave)
# Enclave IP blocks via KADR2
#^{\\\}
# - 10.10.10.48/28
# - 10.10.20.96/28
#^{\\\}
#
[Interface]
#
Address =
fdac:134e:70f8:cf04:0000:0002:0000:0801/64 # 10.0.15.15/32
PrivateKey =
8HkZRtr + Tv8qxWYCZPHyBIVQP2Nvs39X/cD9jNYWVXs=
MTU = 1420
ListenPort = 60725
PostUp = sysctl net.ipv4.conf.all.src_valid_mark = 1
PostUp = sysctl net.ipv4.ip_forward = 1
PostUp = sysctl net.ipv6.conf.all.disable_ipv6 = 0
PostUp = iptables -A FORWARD -i %i -j ACCEPT; iptables -
A FORWARD -o %i -j ACCEPT
PostUp = ip rule add table 100 from 34.x.y.244
PostUp = ip route add table 100 default via 34.x.y.241
PostUp = ip route add 10.10.10.48/28 via 198.18.20.1 dev ens192
PostUp = ip route add 10.10.20.96/28 via 198.18.20.1 dev ens192
PostUp = ip route add 16.x.y.211 via 34.x.y.241 dev ens160
PostDown = iptables -D FORWARD -i %i -j ACCEPT; iptables -
D FORWARD -o %i -j ACCEPT
PostDown = ip rule del table 100 from 34.x.y.244
PostDown = ip route del table 100 default via 34.x.y.241
PostDown = ip route del 10.10.10.48/28
PostDown = ip route del 10.10.20.96/28
[Peer]
# [to HHK1 HOPR in Hong kong]
#
PublicKey =
xWYIflsWxsyVqEEEtRpXFrds0q8qnhHNbP3DHt3DdjA=
Endpoint =
16.x.y.211:60720
AllowedIPs = 0.0.0.0/0
AllowedIPs = 10.77.1.0/29 # HHK-1 internal subnet
PersistentKeepalive = 20

This config file defines the allowed IP addresses to and from which packets will be forwarded to/from the tunnel implemented between the second software node 604 and the third software node 606. The config file also indicates the second software node's private key for decrypting packets received over the tunnel from the third software node 606 and indicates the third software node's public key for encrypting packets sent over the tunnel to the third software node 606. The config file also defines the IP address (“Endpoint”) at which the second software node 606 sends and receives packets via the tunnel.

An example code and configuration package for the third software node 606 includes a Docker compose file and two Docker config files. Two Docker config files are included because the third software node 606 implements two tunnels, one with the first software node 602 and a second with the second software node 604. An example Docker compose file is below:

# HOPR HHK1 in ap-east-1 AWS
# EC2 instance
#
# Aggregates link tunnels from smaller subnets/branches/
nodes and provides subnet level IP forwarding
#
#
#
#
version: “3”
services:
wireguard:
# image: cmulk/wireguard-docker:alpine
# image: registry.gitlab.com/karousels.dev/karousels.span/
sourcegroup/wireguard-docker:alpine
image: registry.gitlab.com/karousels.dev/karousels.span/
sourcegroup/wireguard-docker:alpine-debug
container_name: hopr_hhk_wg
privileged: true
cap_add:
NET_ADMIN
SYS_MODULE
volumes:
. /config:/etc/wireguard/
/lib/modules:/lib/modules
/sys:/sys:rw
ports:
# - “0.0.0.0:60510:60510/udp”
60720:60720/udp
sysctls:
net.ipv4.conf.all.src_valid_mark = 1
net.ipv4.ip_forward = 1
net.ipv6.conf.all.disable_ipv6 = 0
restart: unless-stopped
networks:
hopr_local_net:
ipv4_address: 10.77.1.2
wstunnel:
image:
registry.gitlab.com/karousels.dev/karousels.span/
sourcegroup/wstunnelcontainer_name: hopr-hhk-wstun
restart:
unless-stopped
tty: true
ports:
“443:443/tcp”
# for incoming wstunnel
environment:
SERVER_ADDRESS = 0.0.0.0:443
RESTRICT_TO_ADDRESS = 10.77.1.2:60510
depends_on:
wireguard
networks:
hopr_local_net:
ipv4_address: 10.77.1.3
networks:
hopr_local_net:
driver: bridge
ipam:
driver: default
config:
subnet:
10.77.1.0/29
## EOF - LL

The above code and configuration package is a Docker compose file for the third software node 606. In this example, the third software node 606 is to implement a wstunnel+wireguard tunnel between itself and the first software node 602 as well as a wireguard tunnel between itself and the second software node 604. Thus, the build logic includes an image for wireguard container (image: registry.gitlab.com/karousels.dev/karousels.span/sourcegroup/wireguard-docker:alpine-debug) as well as an image for the wstunnel container (image: registry.gitlab.com/karousels.dev/karousels.span/sourcegroup/wstunnel) in the Docker compose file.

An example of a first config file for the tunnel between the third software node 606 and the first software node 602 is below:

# HOPR in us-west-1 AWS EC2
#
# Private Key:
MKtcazlhu0EEf32JtdQ7R17m9BIYyxis8m2KUxbml3s=
# Public Key:
oll9HHg3V7X4qarpFst + CrQHvzCqlWe20eK96kTBtSk=
#
[Interface]
#
Address =
fdac:134e:70f8:cf04:0000:0002:0000:0201/64
ListenPort =
60510
# connected to wstunnel
MTU =
1420
PrivateKey =
MKtcazlhu0EEf32JtdQ7R17m9BIYyxis8m2KUxbml3s=
PostUp =
iptables -A FORWARD -i % i -j ACCEPT; iptables -
A FORWARD -o % i -j ACCEPT
PostDown =
iptables -D FORWARD -i % i -j ACCEPT; iptables -
D FORWARD -o % i -j ACCEPT
[Peer]
# [ISP-Site-1 KADR1]
#
PublicKey =
JKY7kL/aZhzAGaDopt7JfF4sH3LTjiMCZq2Eh0holmc=
AllowedIPs = 0.0.0.0/0
PersistentKeepalive = 20

This first config file also indicates the third software node's private key for decrypting packets received over the tunnel from the first software node 602 and indicates the first software node's public key for encrypting packets sent over the tunnel to the first software node 602. An example of the second config file is below:

# HOPR in DEV ap-east1-1
# Non wstunnel interface
#
#
# Private Key:
OHIwke5IL7uV7kcXaX80moQCbFUZ2fFy8L +
H9rJ4ZWM=
#
Public Key:
19b3 + VjgGo/GH + NGXKzTu4W +
FAfO9pR19y3BSb/UrCQ=
#
[Interface]
#
Address =
fdac:134e:70f8:cf04:0000:0002:0000:0211/
64 # 10.0.15.10/32
ListenPort = 60720
# Must be exposed in docker-compose
PrivateKey =
0Hlwke5IL7uV7kcXaX80moQCbFUZ2fFy8L +
H9rJ4ZWM=
PostUp =
iptables -A FORWARD -i % i -j ACCEPT; iptables -
A FORWARD -o % i -j ACCEPT
PostDown =
iptables -D FORWARD -i % i -j ACCEPT; iptables -
D FORWARD -o % i -j ACCEPT
# MTU =
1300
[Peer]
# [from KADR2 in dataCenter11]
# Enclave IP blocks via KADR2 in dataCenter10
#^{\\\}
# - 10.10.10.48/28
# - 10.10.20.96/28
# ^{\\\}
#
PublicKey =
L2dqLB04TbyMcEdlAs9HK36IMTqZl1lqvcxbZW6ts38=
AllowedIPs =
10.10.10.48/28, 10.10.20.96/28, 198.18.20.1/32
PersistentKeepalive = 15

This second config file also indicates the third software node's private key for decrypting packets received over the tunnel from the first software node 602 and indicates the first software node's public key for encrypting packets sent over the tunnel to the first software node 602.

Changes (e.g., adds, moves, changes) to the PSAN 610 can be made by an administrator who puts parameters into the system, which then updates the configuration rules 306 and takes the appropriate action. For example, it if is desired to add a third enclave of clients that will access the network service(s) in the first enclave 602, the administrator can input parameters into the system for a fourth software node that functions as a gateway for the third enclave and creates a tunnel between itself and the first software node 602. In response to the information being input, the build logic can create and deploy a code and configuration package for the fourth software node. The build logic can, for example, also create and deploy a new code and configuration package for the first software node 602. The new package can include the function of forming the tunnel with the fourth software node in addition to the previously described functions such as forming the tunnel with the third software node 606. In this way, the system 400 can automatically create and deploy software nodes on demand to update the PSAN 600 based on information received from an administrator.

FIG. 7 is a block diagram of an example device 700 which can host an execution environment for a software node 212. The host device 700 is a physical computing device having one or more processing devices 702 for executing computer readable instructions. The one or more processing devices 702 can include a general-purpose processor or a special purpose processor. The instructions can be stored (or otherwise embodied) on or in an appropriate storage medium 704 or media (such as a hard drive or other non-volatile storage) from which the instructions are readable by the processing device(s) for execution thereby. The one or more processing devices 702 can be coupled to the storage medium 704 or media to access the instructions therefrom. As described in more detail herein, the instructions can include execution environment instructions 710 which, when executed by the processing device(s) 702, cause the host device 700 to perform the functions of an execution environment as described herein. In an example, the execution environment instructions can execute an operating system, a hypervisor, or a Docker Engine as described herein.

The instructions can also include software node instructions 714 which, when executed by the processing device(s) 702, cause the host device 700 to perform the functions of a software node as described herein.

The host device 700 also includes memory 706 that is coupled to the processing device(s) 702 for storing instructions and related data during execution by the processing device(s) 702. Memory 706 can comprise any suitable form of random-access memory (RAM) now known or later developed, such as dynamic random access memory (DRAM). Other types of memory can be used. The host device 700 includes at least one network interface 708, such as an Ethernet interface. In an example, the host device 700 can include a human machine interface (HMI) for interacting with a human.

In an alternative example device 700 can include instructions to implement the methods of FIGS. 3-5. In such an example the instructions on the storage media 704, when executed by the processing device(s) 702, cause the device 700 to perform some or all of the acts of the methods 3-5 described herein. In an example, the acts of methods 3-5 can be performed across multiple devices 700 that are communicatively coupled over a network as described above. For example, a first device 700 can include a HMI that can receive one or more network parameters from a human user. The first device 700 can send the one or more network parameters to a second device 700 that implements that maintains the configuration rules. A third device 700 implements the build logic that accesses the configuration rules. The software nodes 212 can be deployed on still other devices 700.

1. A method of creating a private service access network, the method comprising:
receiving network parameters corresponding to:
a plurality of software nodes;
a first network tunnel between a first client and a first software node of the plurality of software nodes;
a second network tunnel between a second client and a second software node of the plurality of software nodes; and
a third one or more network tunnels between respective software nodes of the plurality of software nodes;
creating a plurality of code and configuration packages that, when executed, each implement a respective software node of the plurality of software nodes, wherein the plurality of software nodes implement the first network tunnel, the second network tunnel, and the third one or more network tunnels,
each of the plurality of code and configuration packages includes execution environment information corresponding to an execution environment in which the respective code and configuration package is to be executed,
deploying each of the plurality of code and configuration packages to the execution environment corresponding to the execution environment information in that code and configuration package; and
causing the one or more execution environments to execute the respective code and configuration package deployed thereto such that the plurality of software nodes provide private network connectivity between the first client and the second client.

2. The method of claim 1, wherein creating one or more code and configuration packages includes assigning at lease one private IP address to the first software node for use as an endpoint of a network connection.

3. The method of claim 1, wherein creating one or more code and configuration packages includes creating a first code and configuration package for the first software node, the first code and configuration package configured to be executed within a first IP subnet and act as a gateway for the first IP subnet.

4. The method of claim 1, wherein creating one or more code and configuration packages include creating a second code and configuration package for the second software node, the second code and configuration package configured to encapsulate and decapsulate packets to and from public IP address to provide a public IP backhaul.

5. The method of claim 1, wherein the network parameters include a tunneling protocol for the network tunnel between the first client and first software nodes.

6. The method of claim 1, wherein the network parameters include one or more of a user-based restriction, a device-based restriction, a location-based restriction, and a time-based restriction.

7. The method of claim 1, wherein creating one or more code and configuration packages includes creating a third code and configuration package for a third software node, the third code and configuration package to implement IP discovery for a first network service and a network connection to the first network service, the third code and configuration package configured to be executed within a first private network.

8. The method of claim 7, wherein creating one or more code and configuration packages includes creating a fourth code and configuration package for a fourth software node, the fourth code and configuration package configured to be executed with a second private network, the second private network hosting the first network service, the fourth code and configuration package configured to implement a network connection between the third software node and the fourth software node for access to the first network service by clients in the first private network.

9. The method of claim 8, wherein creating one or more code and configuration packages includes creating one or more intermediate software nodes between the third software node and the fourth software node with respective network connections therebetween, the one more intermediate software nodes configured to execute within a public network.

10. (canceled)

11. One or more computer readable mediums including instructions, which when executed are configured to:
receive network parameters corresponding to:
a plurality of software nodes;
a first network tunnel between a first client and a first software node of the plurality of software nodes;
a second network tunnel between a second client and a second software node of the plurality of software nodes; and
a third one or more network tunnels between respective software nodes of the plurality of software nodes;
create a plurality of code and configuration packages that, when executed, each implement a respective software node of the plurality of software nodes, wherein the plurality of software nodes implement the first network tunnel, the second network tunnel, and the third one or more network tunnels,
each of the plurality of code and configuration packages including execution environment information corresponding to an execution environment in which the respective code and configuration package is to be executed,
deploy each of the plurality of code and configuration packages to the execution environment corresponding to the execution environment information in that code and configuration package; and
cause the one or more execution environments to execute the respective code and configuration package deployed thereto such that the plurality of software nodes provide private network connectivity between the first client and the second client.

12. (canceled)

13. The one or more computer readable mediums of claim 11, wherein create one or more code and configuration packages includes create a first code and configuration package for the first software node, the first code and configuration package configured to be executed within a first IP subnet and act as a gateway for the first IP subnet.

14. The one or more computer readable mediums of claim 11, wherein create one or more code and configuration packages include create a second code and configuration package for the second software node, the second code and configuration package configured to encapsulate and decapsulate packets to and from public IP address to provide a public IP backhaul.

15. The one or more computer readable mediums of claim 11, wherein the network parameters include an encryption protocol for the first network tunnel.

16. The one or more computer readable mediums of claim 11, wherein the network parameters include one or more of a user-based restriction, a device-based restriction, a location-based restriction, and a time-based restriction.

17. The one or more computer readable mediums of claim 11, wherein create one or more code and configuration packages includes create a third code and configuration package for a third software node, the third code and configuration package to implement IP discovery for a first network service and a network connection to the first network service, the third code and configuration package configured to be executed within a first private network.

18. The one or more computer readable mediums of claim 17, wherein create one or more code and configuration packages includes creating a fourth code and configuration package for a fourth software node, the fourth code and configuration package configured to be executed with a second private network, the second private network hosting the first network service, the fourth code and configuration package configured to implement a network connection between the third software node and the fourth software node for access to the first network service by clients in the first private network.

19. The one or more computer readable mediums of claim 18, wherein create one or more code and configuration packages includes create one or more intermediate software nodes between the third software node and the fourth software node with respective network connections therebetween, the one more intermediate software nodes configured to execute within a public network.

20. (canceled)

21. The method of claim 1, wherein at least one of the first network tunnel and the second network tunnel is encrypted with one or more protocols.

22. The method of claim 1, wherein the first network tunnel is between the first software node and a first private network, such that the plurality of software nodes provide private network connectivity to a plurality of devices in the first private network via the first network tunnel.

23. The one or more computer readable mediums of claim 11, wherein the first network tunnel is between the first software node and a first private network, such that the plurality of software nodes provide private network connectivity to a plurality of devices in the first private network via the first network tunnel.
